(19) United States
(12) Patent Application Publication
(10) Pub. No.: US 2006/0054224 A1
(43) Pub. Date: Mar. 16, 2006

(54) Control valve, nozzle arrangement, and washing unit

(75) Inventors: Uwe Lasebnick, Ditzingen (DE); Simone Eisele, Ingersheim (DE)

Correspondence Address: OSHA LIANG L.L.P., 1221 MCKINNEY STREET, SUITE 2800, HOUSTON, TX, 77010, US

(73) Assignee: Valeo Wischersysteme GmbH, Bietigheim-Bissingen (DE)

(21) Appl. No.: 10/522,355

(22) PCT Filed: Jul. 28, 2003
(86) PCT No.: PCT/EP03/08292

§ 371 Date: Jan. 26, 2005

(30) Foreign Application Priority Data
Jul. 31, 2002 (DE) 102 34 872.3

(51) Int. Cl. B60S 1/52

(52) U.S. Cl. 137/625.48

(57) ABSTRACT

The invention relates to a control valve, a nozzle arrangement and a washing device for vehicle windscreens, the valve having at least two outlets that are coupled or couplable with the nozzle opening or openings, the valve having an inlet that is coupled or couplable with a feed pump for the cleaning fluid, and with provision for a valve body influencing the path of the cleaning fluid from the inlet to the outlets. The invention is characterised in that the valve body is more controllable by the pressure of the cleaning fluid in at least two valve positions.

The invention relates to a control valve for feeding a cleaning fluid to the nozzle opening of a nozzle of a washing bay for vehicle windscreens, as well as a nozzle arrangement and a washing device.

A control valve for feeding a cleaning fluid to nozzle openings of nozzle of a washing device for vehicle windscreens has become known from FR 0 102 306, with the valve having two outlets that are couplable with the nozzle openings, the valve having an inlet that is couplable with a feed pump for the cleaning fluid, and a valve body influencing the path of the cleaning fluid from the inlet to the outlets being provided. The valve is controlled electromagnetically. It has been proven disadvantageous that a power supply must be provided at the valve to control it. Moreover, the provision of such a valve is complicated and expensive on account of the electromagnetic components.

The object of the present invention is therefore to provide a control valve of the type mentioned initially, as well as a nozzle arrangement and a washing device enabling the purposeful control of the valve to be accomplished with ease. In particular, the valve is to be controlled without the use of electricity.

The aforementioned object is achieved by a control valve characterised in that the valve body is controllable in at least two valve positions via the cleaning-fluid pressure.

This entails the advantage that no electrically powered components are to be provided at the control valve. Moreover, there is no need for components that control the valve body by additional means. The invention has the advantage that control of the valve body is accomplished exclusively via the cleaning-fluid pressure. Depending on the pressure of the cleaning fluid, the valve body will be found in a predetermined valve position that influences the path of the cleaning fluid from the inlet to the outlets.

An advantageous embodiment of the invention is characterised in that the valve body is constructed as a sliding element, particularly as a longitudinal sliding element. Longitudinal sliding elements have the advantage of being displaceably mounted in an axial direction between the valve positions. Such a mounting can be effected quite simply. Indeed, instead of longitudinal sliding elements, rotary slide elements can be provided for which have the advantage of being rotatably mounted around their longitudinal axis for controlling the cleaning fluid. This leads to a very compact control-valve construction.

A particularly advantageous embodiment is yielded when the valve body is constructed as a piston slide element, in particular with two piston sections having different-sized pressure-application surfaces. Piston slide elements of this type can be manufactured with little effort and expense, and are easily mountable in appropriate cylinders. In the case of piston-sliding elements with different-sized pressure-application surfaces, different-sized surface forces prevail at the piston sections, depending on the pressure of the cleaning fluid; these surface forces effect a displacement of the piston-sliding element into the respective valve position, according to the pressure of the cleaning fluid.

A particularly favoured embodiment of the invention is characterised in that the valve is constructed as a multi-way slide valve, in particular as a 3/2-way longitudinal slide valve or as a 3/3-way longitudinal slide valve. Valves of this type provide for a total of three connections, to wit, one inlet and two outlets. Depending on the application, two or three valve positions are conceivable.

The use of a valve body in the form of a ball element can also be provided for according to the invention.

A control valve of simple construction is yielded when the valve body can be toggled back and forth between at least two valve positions. In the case of a longitudinal sliding element, the valve positions lie in the axial direction of the valve body. If the valve body is constructed as a rotary slide element, then the valve positions are dependent upon the angle of rotation of the valve body. The provision of just two valve positions has the advantage of both valve positions being final valve positions, in which the location of the valve body can be defined by stops.

An advantageous valve is characterised in that, in a first valve position, especially in a low-pressure position, the valve body connects the inlet with the first outlet, or with the first and second outlet. This allows in the first valve position, cleaning fluid to be fed to the nozzle opening or openings, which is/are coupled with the first outlet or with the first and second outlet.

According to the invention, provision can preferably be made for the valve body in a second valve position—in particular in a high-pressure position—to separate the inlet from the first outlet, and to connect the inlet with the second outlet. In this way, the cleaning fluid is rerouted to the nozzle opening or openings that is/are coupled with the second outlet.

A particularly favoured embodiment of the invention is yielded when a bypass circumventing the valve body in one valve position and connecting the inlet with an outlet is provided for, the input or output of the bypass being closed in at least one other valve position. This has the advantage that a cylindrical valve body can be used that is cost-efficient to manufacture and fit. Depending upon the valve position, the inlet is connected with the one outlet via the cylinder recess that takes the valve body, and/or the inlet is connected with the other outlet via the bypass.

It is particularly advantageous when, in a first valve position, for example in the case of low pressure, the input and output of the bypass (and hence the one outlet as well) are open. In this instance, the other outlet is closed off by the valve body. In a second valve position, for example in the case of high pressure, the output of the bypass is closed via axial displacement of the valve body, causing the one outlet to be separated from the inlet. In this valve position the other outlet is then released, so that cleaning fluid can then flow from the inlet into this outlet.

Furthermore, it is conceivable for a basic position of the valve body to be provided for, in particular a zero-pressure position, in which the valve body separates the inlet from both outlets. In this basic or zero-pressure position, the valve body is advantageously in a non-return valve position. This prevents leakage of the cleaning fluid from the openings in the nozzle body.

In order to allow a planned position of the valve body in the different valve positions, provision can be made for the valve body to be supplied in at least one valve position by the spring force of a spring element, in particular of a helical spring.

Here it is advantageous if the valve body is driven by the spring force against a stop in at least one valve position, enabling a defined position of the valve body to be provided.

Moreover, it is conceivable for the valve body in at least one valve position to act solely against the spring force of the spring element, without being driven against a stop. In this case the valve body is to be found in a floating valve position, in which a balance of forces between the spring force and the force arising from the pressure of the cleaning fluid prevails.

The valve is advantageously disposed in the nozzle body of a nozzle. The nozzle encompassing the valve can be manufactured, handled and fitted as a one-part component. A further advantage of this embodiment is that separate connections between the valve and the nozzle, for example in the form of hoses, are not necessary.

On the other hand, it is conceivable for the valve to be disposed between the feed pump and the nozzle. Here, the valve can be constructed as a separate component.

As an alternative to this, it is also possible according to the invention for the valve to be a part of the feed pump and to be disposed inside the feed pump.

The task mentioned at the outset is furthermore solved by a nozzle arrangement with at least one nozzle, and with a control valve according to the invention connected with the nozzle opening of the nozzle and housed in particular in the nozzle body of the nozzle.

Such a nozzle arrangement advantageously provides for the nozzle's suitability for creating different types of fluid jets, depending on the pressure of the cleaning fluid, and hence depending on which fluid channel carries the cleaning fluid to the nozzle opening in question. It is conceivable, for example, that fluid jets in the form of spot jets are created when the cleaning fluid is fed via the one fluid channel, and that a fluid jet in the form of a flat jet is created when the cleaning fluid is fed via the other fluid channel.

Moreover, the aforementioned task is solved via a washing device for vehicle windscreens with a nozzle arrangement according to the invention, and with a feed pump coupled to the nozzle arrangement for the cleaning fluid.

In this connection, it is advantageous if the valve inlet is connected via a fluid pipe to a feed pump controlling the supply of the cleaning fluid and feeding it at different pressures. Here, the feed pump can be a pump whose speed is controlled or regulated. It is especially advantageous if the pump supplies the cleaning fluid at a different pressure for a different direction of rotation.

The pressure of the feed pump is advantageously controlled as a function of vehicle speed. At a vehicle speed of under 80 km/h, for example, a low pressure of between e.g. 0.2 and 1.4 bar may be created. If the vehicle speed increases to above 80 km/h, the cleaning-fluid pressure achieved by the feed pump is increased e.g. to 1.4 or more bar. At lower speed or pressure, the output of the valve leading to the creation of a flat and/or extensive jet is advantageously opened. At a vehicle speed in excess of 80 km/h, the inlet leading to the creation of a spot jet or a plurality of spot jets is advantageously controlled.

Further advantageous details and embodiments of the invention will be apparent from the following description, in which the invention is described and explained in greater detail by means of the embodiments illustrated in the drawing, which shows:

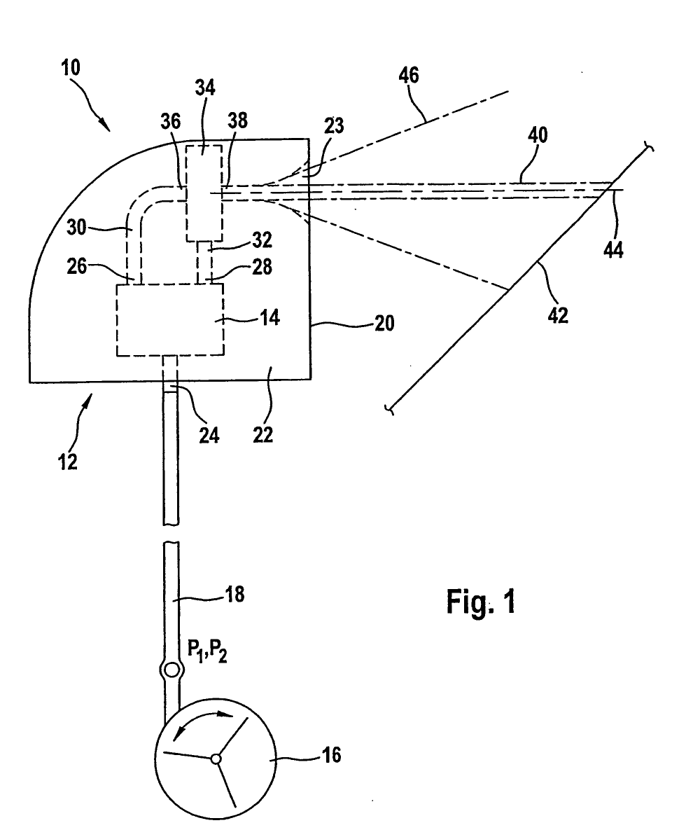

FIG. 1 a washing device according to the invention in systematic representation;

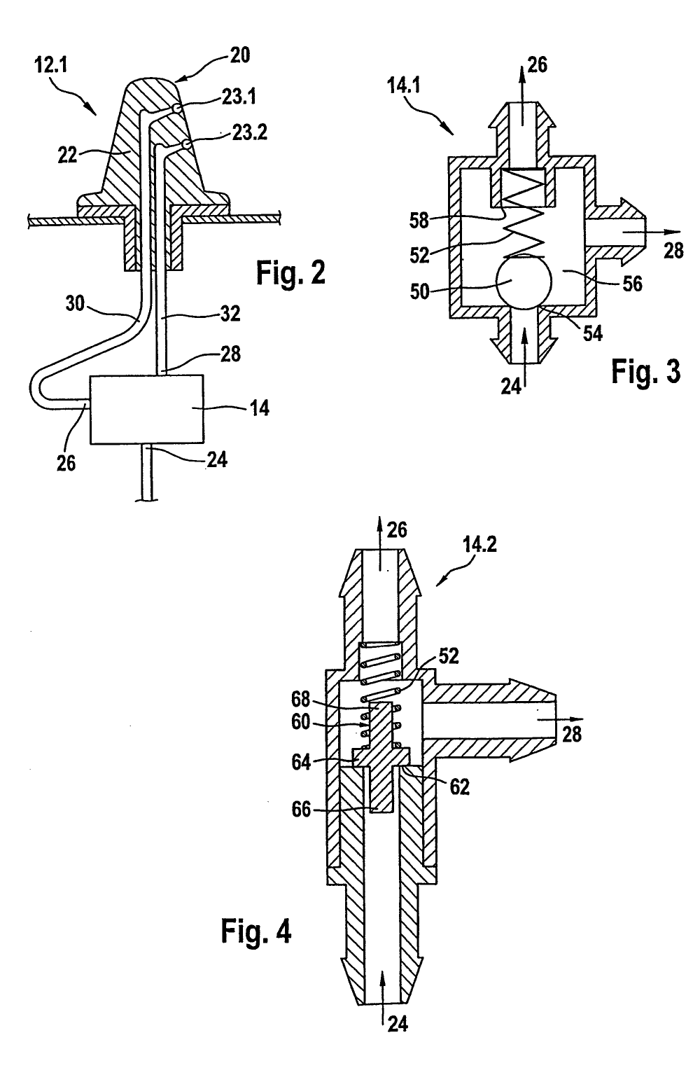

FIG. 2 a nozzle arrangement according to the invention; and

FIGS. 3-7 different embodiments of control valves according to the invention; and

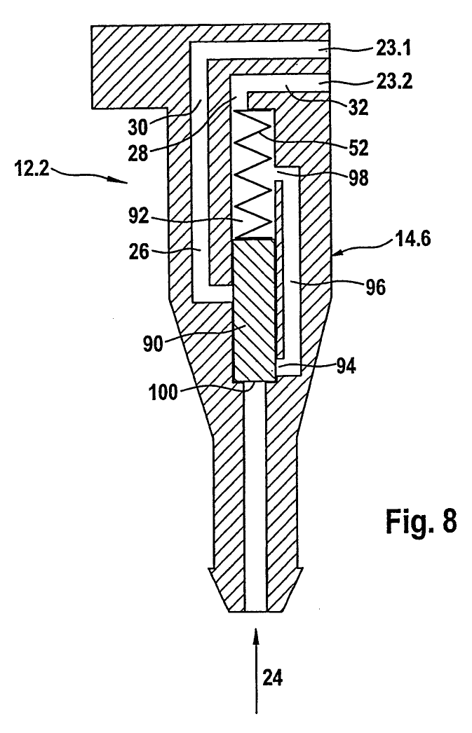

FIG. 8 a further nozzle arrangement according to the invention.

FIG. 1 illustrates a washing device 10 comprising a nozzle arrangement 12, a control valve 14, a feed pump 16 and a pipe 18 between the feed pump 16 and the nozzle arrangement 12. The nozzle arrangement 12 has a nozzle 20 with a nozzle body 22 and a nozzle opening 23. The nozzle 20 or valve 14 provides for a feeder pipe 24 that is detachably connectable with the pipe 18. The control valve 14 provides for a total of two outlets 26, 28 connected with a vortex chamber 34 via fluid channels 30, 32. Channel 32 is so arranged that a fluid jet flowing through channel 30 axially crosses the vortex chamber 34 and runs through the output section 38, arranged between the vortex chamber 34 and the nozzle opening 23. A fluid jet of this type, labelled with reference number 40, strikes the windscreen 42 of a vehicle (not shown) as a spot jet. The axis of the spot jet 40 is labelled with the reference number 44.

If the cleaning fluid enters the vortex chamber 34 via the outlet 28, it is vortexed there and fed to the nozzle opening 23 via the outlet section 38. Because of the vortexing, the cleaning fluid leaves the nozzle opening 23 as a flat or tapered jet 46 and strikes the windscreen 42 over a wide area. The geometry of the jet shape 40, 46 consequently depends on which outlet 26, 28 or channel 30, 32 is used to feed the cleaning fluid to the vortex chamber 34. Moreover, it is conceivable for both outlets 26, 28 to be supplied with cleaning fluid, so that a hybrid jet form of both jets 40 and 46 is created.

The feed pump 16 can, for example, be a pump whose speed is controlled or regulated. It supplies the cleaning fluid at different pressures, to wit, on the one hand at a low pressure P₁ and a high pressure P₂. The low pressure P₁ lies advantageously between 0.2 und 1.4 bar. The high pressure P₂ lies advantageously above 1.4 bar. It is conceivable for the feed pump 16 to be controlled as a function of the vehicle's speed. Here, provision can be made for the pump to supply the cleaning fluid at the pressure P₁ at vehicle speeds below 80 km/h, and at high pressure P₂ at vehicle speeds above 80 km/h.

The path of the cleaning fluid coming from the feed pump 16 to the outlets 26, 28 is influenced via the control valve. The control valve 14 is controlled here by the cleaning-fluid pressure in place at the inlet 24 of the valve 14. The valve 14 is pressure-controlled.

The nozzle arrangement 12 can be a nozzle arrangement 12.1 according to FIG. 2 or 12.2 according to FIG. 8. The valve designated by the number 14 in FIG. 1 and FIG. 2 can be a valve 14.1 to 14.6 in FIGS. 3 to 8.

In FIG. 2, in which a somewhat different nozzle arrangement 12.1 is illustrated, the component parts corresponding to FIG. 1 are labelled with the same reference numbers. According to FIG. 2, the nozzle body 22 of the nozzle 20 provides for two different nozzle openings 23.1 and 23.2. The nozzle opening 23.1 can be provided for to create a spot jet. The nozzle opening 23.2 can be used to create a flat jet. Depending on the valve position of the pressure-controllable control valve 14, the cleaning fluid fed via the inlet 24 is allocated either to the outlet 26 and/or the outlet 28.

In FIGS. 3 to 7, differently constructed control valves 14.1 to 14.5 are illustrated that can be used in a washing bay 10 according to FIG. 1 or a nozzle arrangement 12 according to FIG. 1 or FIG. 2. The inlets of valves 14.1 to 14.5 are all labelled with the reference number 24, and both outlets are labelled 26, 28.

FIG. 3 illustrates a 3/2-way ball valve. A ball element 50 is provided for as a valve body, shown in its neutral zero-pressure position. Via a spring element 52, the inlet 24 is closed in this zero-pressure position via the abutment of the ball element 52 on the inlet-side valve seat 54.

When the pressure at the cleaning fluid is raised to a low pressure P₁, the ball element 50 lifts off from its valve seat 54 against the spring force of the spring element 52. Fluid can then flow into the valve space 56. Here, the low pressure P₁ and the spring force of the spring element 52 are matched to one another such that the ball element 50 is floating in limbo between the valve seat 54 at the inlet 24 and a second valve seat 58 at the outlet 26. Because of this, the cleaning fluid can flow out to both outlets 26, 28.

When the cleaning-fluid pressure is raised to a high pressure P₂, the ball element 50 is driven against the valve seat 28. This closes the outlet 26. Consequently, the cleaning fluid can now only exit from valve 14.1 via the outlet 28.

When the high pressure P₂ or the low pressure P₁ is removed, the valve 14.1 is closed owing to the spring force of the spring element 52; the valve then acts as a non-return valve.

Valve 14.2 illustrated in FIG. 4 substantially corresponds to valve 14.1 according to FIG. 3. Instead of having a ball element as a valve body, the valve 14.2 is provided with a spring-loaded cylindrical sliding pin 60 encompassing a closely abutting collar 64 in the zero-pressure position at a valve seat 62. The sliding pin 60 has the advantage of being so constructed that it is not possible for it to buckle along the axial displacement direction. In this connection, the sliding pin 60 provides for a guide section 66 on the side facing the inlet 24, built relatively long in an axial direction. On the side facing the outlet 26, the sliding pin 60 has a guide section 68 caught in the spring element 52. Because of the guide sections 66, 68 extending in an axial direction, it is not possible for the sliding pin 60 to buckle when axially displaced. Valve 14.2 according to FIG. 4 provides for a total of three valve positions, as does valve 14.1 according to FIG. 3, to wit, the illustrated zero-pressure position, a low-pressure position for which both outlets 26, 28 are open, and a high-pressure position for which only the outlet 28 is open.

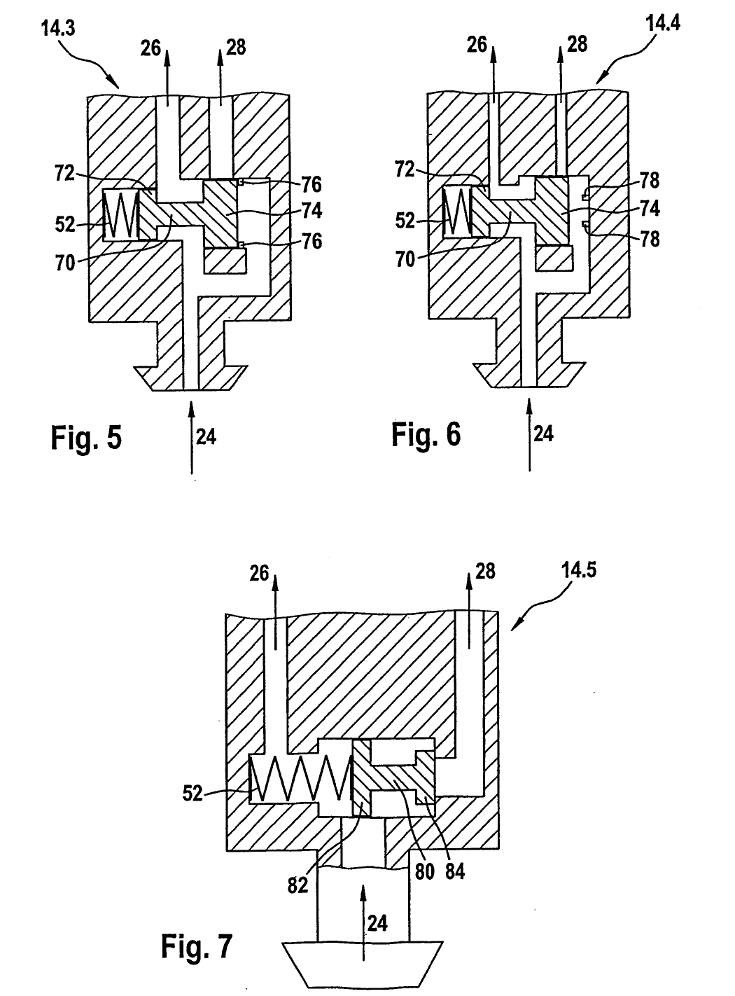

Valve 14.3 illustrated in FIG. 5 is a 3/2-way longitudinal slide valve. This valve does not provide for a non-return valve position at which the inlet 24 is completely cut off from the outlets 26, 28. The inlet 24 is either connected with the outlet 26 or with the outlet 28. To this end, the valve body 70 is constructed as a piston slide element with two different-sized piston sections 72 and 70. In the illustrated basic position, the piston section 74 is driven against stop means 76 via a spring element 52. The diameter of the piston sections 72 and 74 and the spring force of the spring element 52 are in each case so designed that when a threshold pressure is reached, or in the case of fluid high pressure, the piston slide element 70 is displaced axially to the left against the spring force of the spring element 52, breaking off the connection between inlet 24 and outlet 26, and connecting inlet 24 to outlet 28. When the pressure is reduced to the low pressure P₁, the spring force of spring element 52 brings the piston slide element 70 back to the basic position illustrated in FIG. 5. Outlet 28 is then closed, and outlet 26 is opened.

Valve 14.4 illustrated in FIG. 6 is a further development of valve 14.3. In addition, a third switching position of the piston slide element 70 is provided for in which both outlets 26 and 28 are closed. When the pressure of the cleaning fluid is removed, the spring force of the spring element 52 causes the piston slide element to move to the right against stop-peg 78. In this position, not illustrated in FIG. 6, the outlet 26 is closed by the piston section 72 and the outlet 28 by the piston section 74. When pressure is applied to the cleaning fluid with the low pressure P₁, the piston slide element 70 moves into the position illustrated in FIG. 6. Here, there is a balance of forces between the spring force driving the piston slide element 70 to the right, and the force driving the piston slide element 70 to the left, which is the result of the cleaning fluid under low pressure P₁ at the piston sections 70, 74. In this position, the outlet 28 is separated from the inlet 24 by the piston section 74. If the pressure of the cleaning fluid is increased to high pressure P₂, the piston slide element 70 moves further left against the spring force, so that the outlet 26 is separated from the inlet 24. The valve illustrated in FIG. 6 is consequently a 3/3-way longitudinal slide valve.

FIG. 7 illustrates a further valve 14.5 that is constructed as a 3/2-way longitudinal slide valve. According to the embodiments as per FIGS. 5 and 6, the piston slide element 80 provides for two piston sections 82 and 84 having a different diameter. When a low pressure P₁ is applied, the cleaning fluid flows via the inlet 24 to the outlet 26 only. If the pressure is raised to a high pressure P₂, the piston slide element 80 moves against the spring force of the spring 52 to the left, and the outlet 26 is separated from the inlet 24, whilst the outlet 28 is connected to the inlet 24.

Valves 14.1 to 14.5 illustrated in FIGS. 3 to 7 have the advantage that only one pressure-controlled valve body 50, 60, 70, 80 is provided between two or three switching positions. No outside means are required to control the valve bodies. The valves can be designed so small that they can be accommodated within a nozzle body of a nozzle, according to the embodiment as per FIG. 1.

Such an embodiment of a nozzle arrangement 12.2 according to the invention is illustrated in FIG. 8. In this connection, a cylindrical valve body 90 of a valve 14.6 is displaceable axially in a cylinder recess 92 against the spring force of the spring element 52 between a total of three switching positions. In the basic position shown, both outlets 26, 28 are separated from the inlet 24. When the low pressure P₁ is applied to the cleaning fluid at inlet 24, the valve body 90 moves against the spring force of the spring 52 until the input 94 of a bypass 96 is opened. The outlet 26 remains closed off by the valve body 90. The bypass 96 opens out via its output 98, into the area of the cylinder recess 92 facing the outlet 28. The spring force of the spring element 52 is so designed here that when the low pressure P₁ is applied, a balance of forces prevails between the spring force and the force resulting from the cleaning fluid applying low pressure P₁ to the end 100 of the valve body 90.

When the pressure of the cleaning fluid is raised to the high pressure P₂, the valve body 90 is further displaced against the spring force, causing the outlet 26 to be connected with the inlet 24, and the output 98 to be separated from the outlet 28. Consequently, cleaning fluid then flows via the inlet 24 and the outlet 26 or the channel 30 to the nozzle opening 23.1.

The valve 14.6 integrated in the nozzle arrangement 12.2 has the advantage of managing with one piston slide element 90 which is cylindrical, and consequently does not provide for any different piston sections. A valve 14.6 of this type is easy to manufacture and fit.

The cylinder recess 92 provides for a total of five connections, to wit, inlet 24; input 94 of bypass 96, which is adjacent to inlet 24; outlet 26; output 98 of bypass 96, which is adjacent to outlet 28; and outlet 28. Depending upon the axial position of the valve body 90, cleaning fluid can flow via the inlet 24 to the outlets 26, 28. Here, the axial distance between the input 94 and the output 98 of the bypass 96 is designed to be somewhat greater than the axial longitudinal extension of the valve body 90. This ensures the possibility of the valve body 90 being circumvented via the bypass 96. Moreover, the axial distance between the outlet 26 and the output 98 is designed to be slightly smaller than the axial longitudinal extension of the valve body 90. This ensures that the output 98 is closed off before the outlet 26 is opened, which can prevent a drop in pressure from occurring owing to the outlet 26 and the output 98 or the outlet 28 being open at the same time.

The nozzle arrangement 12.2 illustrated in FIG. 8 also has the advantage that the valve body 90 is disposed axially to the inlet 24. This means that the nozzle arrangement 12.3 is very compact in construction, with the inlet 24 being disposed on the one end of the cylinder recess 92 and the outlet 28 on the opposite end. This also contributes to the compact construction of the nozzle arrangement 12.3.

Contrary to an arrangement according to FIG. 8, it is conceivable according to the invention that the different types of valves 14 are available as their own assemblies between the relevant nozzles 20 and the feed pump 16, as shown for example in FIG. 2.

All of the features illustrated in the description, in the drawing and in the following claims may be essential to the invention both individually and in any combination with one other.

1. A control valve for feeding a cleaning fluid to at least one nozzle opening of a nozzle of a washing bay for vehicle windscreens, the valve having at least two outlets that are coupled or couplable with the nozzle opening or the nozzle openings, the valve having an inlet that is coupled or couplable with a feed pump for the cleaning fluid, and in which a valve body influencing the path of the cleaning fluid from the inlet to the outlets is provided for, characterised in that the valve body is controllable via the pressure of the cleaning fluid in at least two valve positions.

2. The control valve according to claim 1, characterised in that the valve body is constructed as a slide element, particularly as a longitudinal or rotary slide element.

3. The control valve according to claim 1, characterised in that the valve body is constructed as a piston slide element with two piston section having different-sized pressure-application surfaces.

4. The control valve according to claim 1, characterised in that the valve is constructed as a multi-way slide valve, in particular as a 3/2-way longitudinal slide valve, or as a 3/3-way longitudinal slide valve.

5. The control valve according to claim 1, characterised in that the valve body is a ball element.

6. ) The control valve according to claim 1, characterised in that the valve body can be toggled back and forth between at least two valve positions.

7. The control valve according to claim 1, characterised in that the valve body in a first valve position, particularly in a low-pressure position, connects the inlet with the first outlet or with the first outlet and the second outlet.

8. The control valve according to claim 1, characterised in that the valve body in a second valve position, particularly in a high-pressure position, separates the inlet from the first outlet and connects the inlet with the second outlet.

9. The control valve according to claim 1, characterised in that a bypass circumventing the valve body in one valve position is provided for which connects the inlet with an outlet, the input or the output of the bypass being closed in at least one other valve position.

10. The control valve according to claim 9, characterised in that in a first valve position, the input and the output of the bypass—and hence also the one outlet—are open, and the other outlet is closed, and that in a second valve position the input of the bypass is open, the output of the bypass is closed—and hence the one outlet is closed, and the other outlet is open.

11. The control valve according to claim 1, characterised in that the valve body in a basic position, particularly in a zero-pressure position, separates the inlet from both outlets.

12. The control valve according to claim 1, characterised in that the valve body in at least one valve position is subjected to the spring force of a spring element, in particular of a helical spring.

13. The control valve according to claim 12, characterised in that the valve body in at least one valve position is driven by the spring force against a stop.

14. The control valve according to claim 1, characterised in that the valve body in at least one valve position acts solely against the spring force of the spring element, without being driven against a stop.

15. The control valve according to claim 1, characterised in that the valve is disposed in the nozzle body of a nozzle.

16. The control valve according to claim 1, characterised in that the valve is disposed between the feed pump and the nozzle.

17. The control valve according to claim 1, characterised in that the valve is disposed in the feed pump.

18. A nozzle arrangement with at least one nozzle and with a valve connected with the nozzle opening of the nozzle and housed in particular in the nozzle body of the nozzle according to claim 1.

19. The nozzle arrangement according to claim 18, characterised in that the nozzle, according to the pressure of the cleaning fluid, and hence according to which fluid channel is used to feed the cleaning fluid to the nozzle opening in question, is suitable for creating different types of fluid jets.

20. A washing device for vehicle windscreens, with a nozzle arrangement according to claim 1, and with a feed pump for the cleaning fluid coupled with the nozzle arrangement.

21. The washing device according to claim 20, characterised in that the inlet of the valve is connected via a fluid pipe to a feed pump that supplies the cleaning fluid, controlled with varying pressure.

22. The washing device according to claim 20, characterised in that the pressure of the feed pump is controlled as a function of vehicle speed.

23. The control valve according to claim 2, characterised in that the valve body is constructed as a piston slide element with two piston section having different-sized pressure-application surfaces.

24. The washing device according to claim 21, characterised in that the pressure of the feed pump is controlled as a function of vehicle speed
